(19) United States
(12) Patent Application Publication
(10) Pub. No.: US 2007/0116613 A1
(43) Pub. Date: May 24, 2007

(54) Sample tube and system for storing and providing nucleic acid samples

(76) Inventor: Donat Elsener, Thun (CH)

Correspondence Address: NOTARO AND MICHALOS, 100 DUTCH HILL ROAD, SUITE 110, ORANGEBURG, NY, 10962-2100, US

(21) Appl. No.: 11/602,846

(22) Filed: Nov. 21, 2006

Related U.S. Application Data
(60) Provisional application No. 60/739,113, filed on Nov. 23, 2005.

(30) Foreign Application Priority Data
Nov. 23, 2005 (CH) 01883/05

(51) Int. Cl. B01L 3/00

(52) U.S. Cl. 422/102

(57) ABSTRACT

A sample tube for storing and providing samples containing nucleic acid and a system having multiple sample tubes in individual receptacle cavities of racks, are robotically transportable together with these racks, for individually storing and providing multiple samples containing nucleic acid, as well as a corresponding use of racks and sample tubes. The preferably 96 or 384 receptacle cavities of the rack, which is preferably provided with an SBS footprint, and the sample tubes are additionally implemented for robotic removal of the sample tubes from the receptacle cavities. The sample tubes have an inner shoulder for accommodating and a clamping body for clamping a single portion containing at least one, preferably individual DNA sample, of a sample carrier, the sample carrier being selected from a group which comprises FTA paper, filter papers, cellulose membranes, and separating gels.

### RELATED PATENT APPLICATIONS

This patent application claims priority of the Swiss Patent Application No. CH 01873/05 as well as of the U.S. Provisional Application No. 60/739,113, both filed on Nov. 23, 2005. The entire disclosure of these two priority applications is enclosed herein by explicit reference for all purposes.

### RELATED FIELD OF TECHNOLOGY

The present invention relates to a sample tube according to the preamble of independent Claim 1 for storing and providing samples containing nucleic acid. The present invention relates to a system according to the preamble of independent Claim 13 having multiple sample tubes situated in individual receptacle cavities of racks and robotically transportable together with these racks. For this purpose, the racks preferably have an SBS footprint. These sample tubes are implemented to store and provide multiple samples containing nucleic acid. In addition, the preferably 96 or 384 receptacle cavities of the racks and the sample tubes are implemented for robotic removal of the sample tubes from these receptacle cavities. Furthermore, the present invention relates to the use of sample tubes situated in individual receptacle cavities of racks having SBS footprints and robotically transportable together therewith. The receptacle cavities of these racks and the sample tubes are additionally implemented for robotic removal of one or more of these sample tubes from these receptacle cavities. Moreover, the present invention relates to the use of sample carriers for storing and providing samples containing nucleic acid.

Deoxyribonucleic acid (DNA) in blood samples, referred to in the following in short as “blood DNA”, is used for diagnosing genetically caused diseases, for diagnosing and monitoring parasitic illnesses in the blood, such as malaria, for determining paternity, and for monitoring other unusual cell populations in the blood, as may occur in the event of neoplasias. In connection with the present invention, the expression “blood DNA” is used here, all DNA sources which may normally occur in the blood also being meant thereby. Therefore, this term also comprises the DNA of the patient from whom the blood was taken, but also all DNA in any organisms circulating in the blood of this patient.

The term “DNA sample” comprises, in addition to the above-mentioned “blood DNA”, all samples which contain nucleic acid, whether this is deoxyribonucleic acid (DNA) and/or ribonucleic acid (RNA). All living beings, such as humans, animals, plants, and microorganisms, but also viruses, may be used as sources for these nucleic acids, which may additionally also be produced synthetically. The nucleic acids may also originate from biochemical libraries.

### RELATED PRIOR ART

A solid medium, using which blood DNA, or nucleic acid samples in general, may be stored and transported, is known from the prior art (cf., for example, U.S. Pat. No. 5,496,562). This dry medium consists of a solid matrix based on cellulose and a compound which essentially consists of a weak base, a chelating agent for binding metallic ions, an anionic surfactant agent or an anionic detergent, and possibly uric acid or a urea salt. This medium is known under the name FTA paper and is distributed, for example, by Whatman plc, Kent ME16 OLS (England) under the names WHATMAN® or FTA® TECHNOLOGY, for example. The chemicals contained in the FTA paper lyse the blood cells and conserve the DNA. These chemicals are activated when a biological liquid contacts the surface of the FTA paper. An additional property of this chemical treatment is the inactivation of bacteria and viruses. The samples are thus protected from contamination and growth of microorganisms. In addition, however, the user is protected from a possible biological accident (biohazard). Normally, disk-shaped portions of this carrier medium having a diameter of approximately 1.2 mm are stamped by hand from these FTA papers provided with a blood sample and transferred into test tubes. The disks are then washed step-by-step by dispensing a special cleaning agent into these test tubes, shaking these test tubes, and then suctioning out the cleaning agent again.

In addition to the FTA paper, filter papers, cellulose membranes, and separating gels may also be used as carrier media (or simply “carriers” or “sample carriers”) for samples containing nucleic acid.

The blood DNA may also originate from a person suspected of a crime, however. The laboratory of the South African Police Service (SAPS) specializing in forensic science has occupied itself with establishing a completely automated laboratory for genetic identification. For this reason, the SAPS maintains a forensic DNA database. A Marshall cassette is known from the SAPS, which is formed by a plastic frame having a bar code and three wells inserted into this frame, each having an FTA paper. The three FTA papers are each provided with a drop of blood during the blood sampling, which dries within a few minutes. These charged cassettes are then transported into the laboratory. In contrast to the standard procedure described above, the cassettes are first washed using vacuum filtration in a robotic liquid handler and then dried in an incubator. Only then are disk-shaped samples stamped out of the FTA papers and transferred into a PCR plate (PCR=polymerase chain reaction) having 96 wells, which is provided with a bar code. A second robotic liquid handler dispenses the normally used PCR reaction mixture into the 96 wells of the PCR microplate, which is then covered by a heat resistant film. The polymerase chain reaction for enriching the DNA contained in the samples is then performed.

A large number of racks for storing and transporting sample tubes is known from the prior art (e.g., from ABgene, Epsom, KT19 9AP, United Kingdom). In robotic laboratories, “microtube cluster racks” are especially preferred, because these have a footprint which corresponds to the “footprint” of a microplate according to the SBS standard (SBS=Society for Biomolecular Screening) and is therefore often referred to as the “SBS footprint”. In the meantime, this standard has been normalized by the ANSI (American National Standards Institute) as ANSI/SBS 1-2004. Racks having 96 microtubes are known. The current application also distributes microtube cluster racks having 96 or 384 microtubes under the trade name REMP Tube Technology™. These differ from the racks and microtubes from the other prior art essentially in that the sample tubes are provided by situating at least two racks one over another and pushing sample tubes using a manipulator from the upper racks into correspondingly positioned receptacle cavities of the lower rack. Vice versa, this transfer process may also be performed by pushing sample tubes using a manipulator from the bottom rack into correspondingly positioned receptacle cavities of the upper racks (cf., for example, EP 0 904 841 B1 or U.S. Pat. No. 6,827,907 B2).

The company GenVault (Carlsbad, Calif. 92008, USA) has selected another approach, in that it offers microplate having 384 wells, for example, which are all connected to one another by a shared FTA paper. 384 aliquots of the same sample thus result using approximately 4 ml of a blood sample. Alternatively to this, a disk of an FTA paper having a diameter of approximately 3.4 mm is laid in each of the 384 wells of a microplate, so that 384 different samples may be housed on one microplate. Microplates, which are subdivided into six regions each having 40 aliquots are also offered as a compromise.

### OBJECTS, SUMMARY, AND ADVANTAGES OF THE INVENTION

All methods up to this point known from the prior art, which use FTA paper are not suitable for the robotic provision of individual DNA samples. The present invention is thus based on the object of improving the robotic provision of individual DNA samples on FTA papers or other carriers.

This object is achieved according to a first aspect in that a sample tube for storing and providing samples containing nucleic acid is suggested, which is characterized in that it has an inner shoulder for receiving and a clamping body for clamping a single portion of a sample carrier containing at least one DNA sample, the sample carrier being selected from a group which comprises FTA paper, filter papers, cellulose membranes, and separating gels.

This object is achieved according to a second aspect in that a system having multiple sample tubes, which are situated in individual receptacle cavities of racks and are transportable robotically together with these racks, is suggested for the individual storage and provision of multiple samples containing nucleic acid. The preferably 96 or 384 receptacle cavities of the rack, which is preferably provided with an SBS footprint, and the sample tubes are additionally implemented for robotic removal of one or more of the sample tubes from these receptacle cavities. Each sample tube has an inner shoulder for receiving and a clamping body for clamping a single portion containing at least one, preferably individual DNA sample, of a sample carrier, the sample carrier being selected from a group which comprises FTA paper, filter papers, cellulose membranes, and separating gels. The system according to the present invention is characterized in that it comprises least two racks which may be situated one above another and at least one manipulator, whereby the racks may be positioned one above another in the system in such a way that at least a part of their cavities stand one below another in the register, and whereby a manipulator is implemented to push sample tubes from an upper rack into correspondingly positioned receptacle cavities of a lower rack and/or a manipulator is implemented to push sample tubes from a lower rack into correspondingly positioned receptacle cavities of an upper rack.

This object is achieved according to a third aspect in that the use of sample tubes situated in individual receptacle cavities of racks having an SBS footprint and transportable together therewith and of sample carriers for storing and providing samples containing nucleic acid is suggested. The receptacle cavities of the racks and the sample tubes are additionally implemented for the robotic removal of one or more of these sample tubes from these receptacle cavities; whereby a portion of the sample carrier containing at least one DNA sample is stored in a sample tube in each case and this sample tube is positioned in a receptacle cavity of a rack, after which the sample tubes having the sample containing nucleic acid are provided in a predetermined and variable number, preferably 1 through 384 sample tubes, and whereby the sample carriers are selected from a group which comprises FTA paper, filter papers, cellulose membranes, and separating gels. The particular portion preferably contained in an individual sample may be attached clamped in the sample tube or simply laid in this tube, if these sample tubes have a lower terminus. The use according to the present invention is characterized in that at least two racks are situated one above another in such a way that at least a part of their receptacle cavities stand one below another in the register, and wherein sample tubes from an upper rack are pushed into correspondingly positioned receptacle cavities of a lower rack and/or sample tubes are pushed from a lower rack into correspondingly positioned receptacle cavities of an upper rack, using at least one manipulator.

Additional preferred features according to the present invention result from the dependent claims.

Advantages which result from the use of the sample tube according to the present invention and/or a system using such a tube comprise the following aspects:
selective access to individual single samples, which are stored in individual sample tubes in racks or have been inserted fresh into such tubes;
arbitrary assembly of sets of these single samples;
arbitrary combination of such sets;
arbitrary grouping of specific samples within these sets;
arbitrary regrouping of these sets by transferring sample tubes to other racks.

### BRIEF INTRODUCTION OF THE DRAWINGS

The sample tubes according to the present invention, the system according to the present invention, and the use according to the present invention will be explained in detail on the basis of schematic figures of exemplary embodiments which do not restrict the scope of the present invention. These Figures show in:

FIG. 1 a longitudinal section of a sample tube according to the present invention according to a first embodiment;

FIG. 2 a longitudinal section of a sample tube according to the present invention according to a second embodiment;

FIG. 3 a longitudinal section of a sample tube according to the present invention according to a third embodiment;

FIG. 4 a longitudinal section of a sample tube according to the present invention according to a fourth embodiment;

FIG. 5 a longitudinal section of a sample tube according to the present invention according to a fifth embodiment;

FIG. 6 a longitudinal section of a sample tube according to the present invention according to a sixth embodiment;

FIG. 7 a vertical section through a configuration of two parts of a sample tube for stamping out a sample portion, wherein:

FIG. 7A shows placement of a sample carrier on the bottom part of the sample tube, supported by a holder;

FIG. 7B shows stamping out of a sample portion from the sample carrier using the blade of the upper part of the sample tube;

FIG. 7C shows clamping of the sample portion and assembly of the two parts of the sample tube to form a seal;

FIG. 8 a reworked, three-dimensional illustration of a rack and of sample tubes from the prior art (cf. FIG. 1 in U.S. Pat. No. 6,827,907);

FIG. 9 a vertical section through the configuration of at least two racks according to the system, based on the sample tubes according to the present invention, for transferring sample tubes from one rack to another.

### DETAILED DESCRIPTION OF THE INVENTION

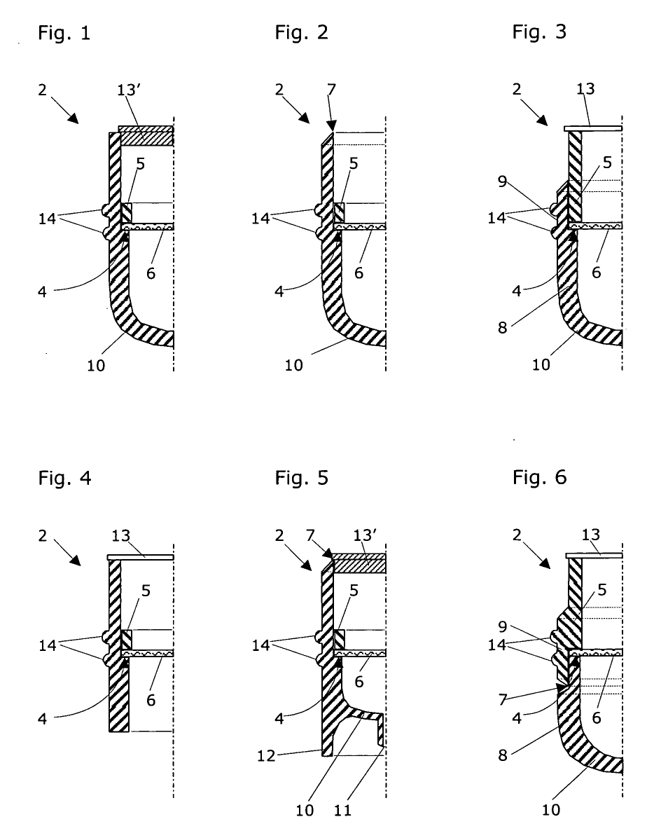

FIG. 1 shows a longitudinal section of a sample tube according to the present invention according to a first embodiment. This sample tube 2 is implemented to store and provide samples containing nucleic acid. For this purpose, it has an inner shoulder 4 for receiving and a clamping body 5 for clamping a single portion 6 of a sample carrier, preferably containing in individual DNA sample. This sample carrier may be an FTA paper, a filter paper, a cellulose membrane, or a separating gel. A stamped-out, disk-shaped portion 6 of this sample carrier is preferably clamped at its edge between the inner shoulder 4 and the clamping body. It is not decisive whether or not the disk-shaped portion 6 is clamped around its entire circumference between shoulder 4 and clamping body 5. The portion 6 may also have shapes deviating from a circular disk; a triangular, rectangular, or polygonal shape of the portion 6 is also possible. Moreover, this portion may also be separated from the remaining carrier medium by being cut out. It is important, however, that at least a part of the edge of this portion (whether this is only a few fibers of a filter paper) is clamped between shoulder 4 and clamping body 5, so that this portion may not be flushed out of the tube during washing procedures, for example, or otherwise lost. The clamping body 5 is implemented to be situated within the sample tube 2. It is implemented as ring-shaped here. Notwithstanding this illustration, the clamping body 5 may also be implemented as star-shaped or box-shaped. It may also have a combination of these shapes or a grid structure. It is important that this clamping body 5 may be situated in a friction lock within the tube 2, so that it assumes a secure seat and clamps parts of the sample carrier between itself and the shoulder 4. If additional parts of the sample carrier are clamped between the clamping body and the essentially vertical inner wall of the tube, this is entirely desirable, because it additionally serves to fix the sample carrier in the tube.

This sample tube 2 according to the first embodiment has a lower terminus 10, which closes the lower part of the sample tube 2. In addition, this tube is closed at its top using a stopper 13′ or a “cap”. In this case, the caps which are offered by the current applicant as REMP CAPMAT96 or as single such caps are especially preferred. This sample tube 2 may also be closed at its top using a film 13 (cf., for example, FIG. 3 or 4). In this case, closing using a film applicable with heating, which is distributed under the trade name REMP THERMO-SEAL™ by the current applicant, is especially preferred.

FIG. 2 shows a longitudinal section of a sample tube according to the present invention according to a second embodiment. Like the sample tube 2 in FIG. 1, this tube is implemented as essentially cylindrical and has mostly the same features. However, in contrast to the first tube cited, it has a blade 7 on its top, which is capable of stamping out a portion 6 of a sample carrier to be accommodated. Because of the uppermost surface of the sample tube 2, which is essentially reduced to a circular line by the blade 7, closure using a stopper 13′ is more suitable here than the use of a thermal film 13 (cf., for example, FIG. 5).

FIG. 3 shows a longitudinal section of a sample tube according to the present invention according to a third embodiment. Like the sample tube 2 in FIG. 1, this tube is also implemented as essentially cylindrical and has mostly the same features. However, in contrast to the first tube cited, this tube has a clamping body 5 which is an essentially cylindrical top part of the sample tube 2. This sample tube 2 additionally comprises a bottom part 8 which is implemented so it may be plugged together with this top part 5 to form a seal. The bottom part 8 of the sample tube 2 has a blade 7 on its top end for stamping out a portion 6 of a sample carrier to be accommodated. Like that in FIG. 1, this sample tube 2 is also closed at its top. In contrast to that tube, this sample tube 2 is closed using a film 13. In this case, closure using a film applicable with heating, which is distributed under the trade name REMP THERMO-SEAL™ by the current applicant, is especially preferred. The closure of the sample tube 2 may be performed already before the stamping out of the sample portions. The use of a clear, transparent film, REMP CLEAR THERMO-SEAL™, is especially preferred, because, for example, in the case of a blood DNA sample, the blood droplet may be sighted during the stamping out. If the sample tube 2 is to be closed only after the stamping out and clamping of the sample carrier, other films, such as REMP PIERCABLE THERMO-SEAL™ or REMP REMOVABLE THERMO-SEAL™, may also be used, depending on whether the film is to be pierced by the needle of a pipette during the processing of the sample or is to be removed for this processing.

FIG. 4 shows a longitudinal section of a sample tube according to the present invention according to a fourth embodiment. Like the sample tube 2 in FIG. 1, this tube is implemented as essentially cylindrical and has mostly the same features. However, in contrast to the first tube cited, this tube has no lower terminus 10 on its bottom, so that it is open on the bottom. This embodiment has the advantage that the washing solutions may simply be flushed through. However, it must be ensured that the neighboring samples may not thus be contaminated. If the film 13 is implemented as pierceable by needles and self-sealing again for this fourth embodiment, the tubes may be inverted after the thorough washing, so that the film 13 forms the lower terminus. In addition, the inverted tube may additionally be closed on its now open top using a film 13 or using a stopper 13′. In this embodiment, it is of the greatest importance that the sample portion 6 is attached securely in the sample tube 2, i.e., clamped and retained.

FIG. 5 shows a longitudinal section of a sample tube according to the present invention according to a fifth embodiment. Like the sample tube 2 in FIG. 2, this tube is implemented as essentially cylindrical and has mostly the same features. This tube also has a blade 7 on its top, which is capable of stamping out a portion 6 of a sample carrier to be accommodated. Because of the uppermost surface of the sample tube 2, which is reduced essentially to a circular line by the blade 7, closure using a stopper 13′ is more suitable here than the use of a thermal film 13. However, in contrast to the tube of FIG. 2, this tube has a lower terminus 10 on its bottom which has an outlet capillary 11 in the middle. The diameter and the length of this capillary are dimensioned in such a way that without application of centrifugal forces to the tube, an excess pressure to its top part, or a partial vacuum to its bottom part, no liquid may exit spontaneously from the capillary. Thus, for example, washing liquids may be pipetted from above into the tube and also suctioned out again from above. However, if liquid is to come out of the capillary 11, one of the means just cited may be used to empty the sample tube 2. To reduce the danger of contamination for neighboring samples, this tube additionally has a peripheral droplet barrier 12.

FIG. 6 shows a longitudinal section of a sample tube according to the present invention according to a sixth embodiment. Like the sample tube 2 in FIG. 3, this tube is implemented as essentially cylindrical and has mostly the same features. This tube also has a clamping body 5, which is an essentially cylindrical top part of the sample tube 2. This sample tube 2 additionally comprises a bottom part 8, which is implemented so it may be plugged together with this top part 5 to form a seal. A top part 5 which has a sleeve 9 on its bottom end for the insertion, to form a seal, of the particular other part of the sample tube 2 is especially preferred. This sleeve 9 advantageously reinforces a tube which is thin-walled per se. The top part 5 has a blade 7 on its bottom end for stamping out a portion 6 of a sample carrier to be received. The bottom part 8 of the sample tube 2 has a shoulder 4 on its top end for accommodating this portion 6. Like the tube in FIG. 3, this sample tube 2 is also closed at its top using a film 13.

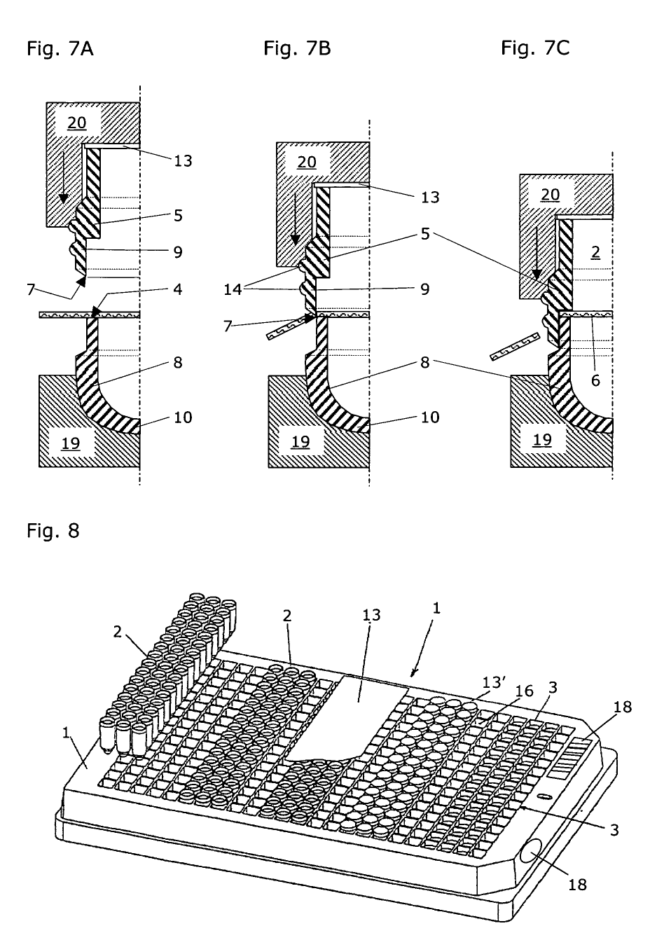

FIG. 7 shows a vertical section through a configuration of two parts of a sample tube for stamping out a sample portion. The sample tube 2 shown corresponds to the sixth embodiment (cf. FIG. 6) and the top part 5 is preferably closed using a clear, transparent film 13 of the type REMP CLEAR THERMO-SEAL™. Three essential steps of the sample enclosure are shown:

In FIG. 7A, a sample carrier is placed on the bottom part 8 of the sample tube 2, supported by a holder 19, in such a way that the DNA sample is situated practically in the axis of the sample tube. The top part 5 assigned thereto is positioned so that its axis corresponds to that of the bottom part 8. For simpler tracking and/or for visual monitoring of this procedure, the tool 20, using which the top part 5 is guided, is implemented as transparent or has a transparent part (not shown) at least in the area of the sample tube 2.

In FIG. 7B, the top part 5 of the sample tube 2 is lowered using the tool 20. This tool may be moved by hand or by a robot. The blade 7 at the lower end of the top part 5 cuts off the excess part of the sample carrier—a sample portion is thus stamped out of the sample carrier.

In FIG. 7C, the cut-off sample portion is clamped on the shoulder 4 of the bottom part 8 by the further lowering of the top part 5. In addition, the two parts of the sample tube 2 are joined together to form a seal. If this has not yet occurred, each sample tube 2 may be closed individually using a film 13 or using a stopper 13′. This tube may subsequently be inserted in a rack 1 (cf. FIG. 8).

Instead of lowering the top part 5 or combined therewith, the bottom part 8 of the sample tube 2 may also be raised; the orientation of the two parts 5,8 of a sample tube 2 may also be performed by the movement of the bottom part 8 (both not shown).

FIG. 8 shows a reworked, three-dimensional illustration of a rack 1 and of sample tubes from the prior art (cf. FIG. 1 in U.S. Pat. No. 6,827,907). A system having multiple such racks 1 having an SPS footprint is also known from U.S. Pat. No. 6,827,907. These racks 1 have—on the basis of standard microplates—a number of, for example, 96, 384, or 1536 individual receptacle cavities 3, in each of which a sample tube 2 is individually situated. Large numbers of sample tubes 2 are thus transportable robotically together with these racks 1. This transport is preferably performed using a microplate handler. The sample tubes 2 may be used for the individual storage and provision of multiple samples containing nucleic acid and are also themselves transportable robotically from one rack 1 to another. Any of the sample tubes 2 known from U.S. Pat. No. 6,827,907, but also each of the sample tubes 2 according to the present invention, may be inserted in such racks 1 and transferred from one rack to another robotically. Each of the sample tubes 2 according to the present invention used in this system has an inner shoulder 4 for accommodating and a clamping body 5 for clamping a single portion 6 of a sample carrier containing an individual DNA sample.

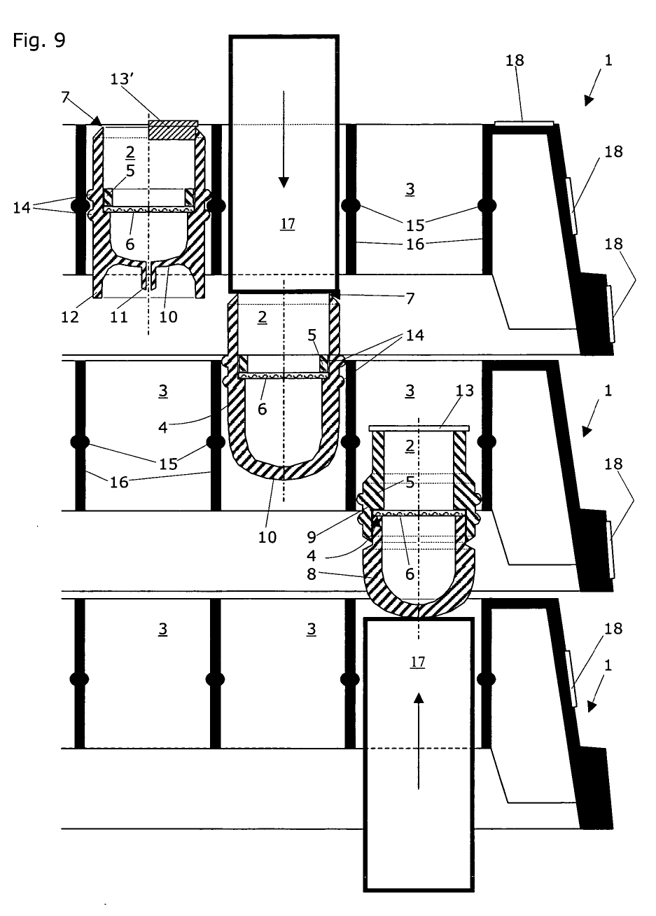

For use with the racks 1 in such a system, each sample tube 2 preferably has two parallel ribs 14 on its outer circumference, which are used for positioning the sample tubes 2 on protrusions 15 of partition walls 16, which separate the receptacle cavities 3 of a rack 1 from one another (cf. also FIG. 9), by being snapped in. While simpler systems may only accommodate one rack 1, preferred systems comprise at least two racks 1 which may be positioned one above another and at least one manipulator 17 for pushing sample tubes 2 from the upper rack 1 into correspondingly positioned receptacle cavities 3 of the lower rack. Alternatively, such preferred systems comprise at least two racks 1, which may be positioned one above another, and at least one manipulator 17 for pushing sample tubes 2 from the lower rack 1 into correspondingly positioned receptacle cavities 3 of the upper rack 1.

The tubes from the prior art and the sample tubes 2 according to the present invention may, however, also be used in those systems which use racks in three planes lying one above another—at the same or different stations—so that sample tubes 2 may be pushed from the uppermost rack 1 into the middle rack 1 and, simultaneously or sequentially, sample tubes 2 may be pushed from the lowermost rack 1 into the middle rack 1.

All of these systems may be equipped with manipulators 17 which are implemented for simultaneously pushing two or more sample tubes 2. Thus, for example, entire columns or rows of sample tubes 2 may be transferred simultaneously from one rack to another. Alternative manipulators may be implemented for pulling sample tubes 2 out of the racks 1 (not shown).

The racks 1 preferably have an SPS footprint and are preferably provided with an identification 18, so that the racks 1 may be identified at any time. Such an identification 18 preferably comprises a bar code, a radio frequency identification tag, i.e., an RFID tag, or both. It is to be noted that RFID tags are especially preferred in particular, because their scope of stored information may be much greater than in a bar code. In addition, in contrast to the bar code, no direct visual contact is necessary to retrieve the information of an RFID tag. Moreover, further information, such as processing of the samples which has already been performed, may also be added to RFID tags.

FIG. 9 shows a vertical section through the configuration of at least two racks according to the system based on the sample tubes 2 according to the present invention for transferring sample tubes from one rack to the other. Each of the sample tubes 2 according to the present invention preferably has two parallel ribs 14 on its outer circumference for positioning the sample tubes 2 on protrusions 15 of partition walls 16, which separate the receptacle cavities 3 of a rack 1 from one another, by being snapped in. These ribs 14 are also visible in FIGS. 1 through 7. Alternatively, each sample tube 2 may also have a horizontally running depression, in which a corresponding protrusion 15 of partition walls 16, which separate the receptacle cavities 3 of a rack 1 from one another, may engage by being snapped in. Such a depression results, for example, from the sixth embodiment shown between the sleeve 9 of the top part 5 of the sample tube 2 and a shoulder at the circumference of the bottom part 8 thereof (cf. FIGS. 6 and 7). In addition, such a horizontal depression may be provided at almost any point of the sample tube 2 according to the present invention, independently of whether it is implemented in one piece (cf. FIGS. 1, 2, 4, and 5) or in two pieces (cf. FIGS. 3, 6, and 7).

A further alternative for positioning the sample tube 2 by being snapped in at a predefined height in a cavity 3 of a rack 1 results in that protrusions on sample tubes 2 may engage in depressions of partition walls (not shown).

An essentially vertically movable manipulator 17 is just pushing one sample tube 2 from the uppermost of three racks 1 into the middle rack in FIG. 9. Simultaneously, a manipulator 17, which is also movable essentially vertically, pushes precisely one sample tube 2 from the lowermost of three racks 1 into the middle rack. This is possible because all three compartments 3 of the preferably identically implemented racks 1 are accessible in the same way from above and from below and because the racks 1 may be positioned one above another in a system having multiple sample tubes 2 situated in individual receptacle cavities of racks 1 having an SPS footprint and robotically transportable together with these racks 1 for individually storing and providing multiple samples containing nucleic acid in such a way that the cavities 3 stand one below another in the register. If one of the racks 1 (e.g., the middle rack) is moved between the transfer of the sample tubes 2, which may occur on a stage, for example, each of the sample tubes 2 from the uppermost or lowermost rack 1 may be pushed to any arbitrary cavity position of the middle rack 1, if this position is not yet occupied.

Of course, in a system which only positions two racks 1 one above the other at a time, manipulators 17 may also be used from above, below, or from both sides (not shown). In addition, the application locations of the information 18 may deviate from those shown. Thus, for example, RFID tags may also be attached to the interior of the racks 1, for example, where they may not be damaged by microplate handling robots.

A combination of the features shown and/or described of the sample tube 2 according to the present invention which is obvious to those skilled in the art is within the scope of the present invention, even if the individual feature combinations are not expressly described in each case.

List of Reference Numerals:

1 rack
2 sample tube
3 receptacle cavity
4 inner shoulder
5 clamping body; top part
6 portion containing DNA sample
7 blade
8 bottom part
9 sleeve
10 lower terminus
11 outlet capillary
12 peripheral droplet barrier
13 film
13′ stopper
14 parallel rib
15 protrusion
16 partition wall
17 manipulator
18 identification
19 holder
20 tool

What is claimed is:

1. A sample tube for storing and providing samples containing nucleic acid,
wherein the sample tube has an inner shoulder for accommodating and a clamping body for clamping a single portion of a sample carrier containing at least one DNA sample, the sample carrier being selected from a group which comprises FTA paper, filter papers, cellulose membrane, and separating gels.

2. The sample tube according to claim 1,
wherein the portion of the sample carrier contains a single individual DNA sample.

3. The sample tube according to claim 1,
wherein the clamping body is implemented to be situated inside the sample tube.

4. The sample tube according to claim 3,
wherein the clamping body is implemented as ring-shaped, star-shaped, or box-shaped.

5. The sample tube according to claim 1,
wherein the sample tube is implemented as essentially cylindrical and has a blade on its top for stamping out a portion of a sample carrier to be accommodated.

6. The sample tube according to claim 1,
wherein the clamping body is an essentially cylindrical top part of the sample tube, this sample tube additionally comprising a bottom part, which is implemented so it may be plugged together with this top part to form a seal.

7. The sample tube according to claim 6,
wherein the top part has a blade on its lower end and/or the bottom part has a blade on its upper end for stamping out a portion of a sample carrier to be accommodated.

8. The sample tube according to claim 6,
wherein the top part has a sleeve on its lower end or the bottom part has a sleeve on its upper end for inserting the particular other part of the sample tube to form a seal.

9. The sample tube according to claim 1,
wherein the sample tube has a lower terminus.

10. The sample tube according to claim 9,
wherein the lower terminus of the sample tube has an outlet capillary.

11. The sample tube according to claim 10,
wherein the outlet capillary is situated centrally and the lower terminus of the sample tube additionally has a peripheral droplet barrier.

12. The sample tube according to claim 1,
characterized in that each sample tube is closed on its top using a film or a stopper.

13. A system having multiple sample tubes, which are situated in individual receptacle cavities of racks and are robotically transportable together with these racks, for individually storing and providing multiple samples containing nucleic acid, the preferably 96 or 384 receptacle cavities of the racks and the sample tubes additionally being implemented for the robotic removal of these sample tubes from these receptacle cavities, each sample tube having an inner shoulder for accommodating and a clamping body for clamping a single portion of a sample carrier containing at least one DNA sample, the sample carrier being selected from a group which comprises FTA paper, filter papers, cellulose membranes, and separating gels,
wherein the system comprises least two racks which may be situated one above another and at least one manipulator, whereby the racks may be positioned one above another in the system in such a way that at least a part of their receptacle cavities stand one below another in the register, and whereby a manipulator is implemented to push sample tubes from an upper rack into correspondingly positioned receptacle cavities of a lower rack and/or a manipulator is implemented to push sample tubes from a lower rack into correspondingly positioned receptacle cavities of an upper rack.

14. The system according to claim 13,
wherein the portion of the sample carrier has a single individual DNA sample.

15. The system according to claim 13,
which comprises sample tubes each containing a single individual DNA sample, the racks having an SBS footprint.

16. The system according to claim 13,
wherein each sample tube has two parallel ribs on its outer circumference for positioning the sample tubes on protrusions of partition walls, which separate the receptacle cavities of a racks from one another, by being snapped in.

17. The system according to claim 13,
wherein the manipulator is implemented for simultaneously pushing two or more sample tubes.

18. System according to claim 13,
wherein the racks comprise an identification, preferably an RFID tag or barcode.

19. A use of sample tubes, which are situated in individual receptacle cavities of racks having an SBS footprint and are robotically transportable together therewith, the receptacle cavities of the racks and the sample tubes additionally being implemented for the robotic removal of one or more of the sample tubes from these receptacle cavities; and of sample carriers for storing and providing samples containing nucleic acid, in each case a portion of a sample carrier containing at least one DNA sample being stored in a sample tube and the sample tube being positioned in a receptacle cavity of a rack, after which the sample tubes having the samples containing nucleic acid being provided in a predefined and variable number of preferably 1 through 384 sample tubes, the sample carriers being selected from a group which comprises FTA paper, filter papers, cellulose membranes, and separating gels,
wherein at least two racks are situated one above another in such a way that at least a part of their receptacle cavities stand one below another in the register, and wherein sample tubes from an upper rack are pushed into correspondingly positioned receptacle cavities of a lower rack and/or sample tubes are pushed from a lower rack into correspondingly positioned receptacle cavities of an upper rack, using at least one manipulator.

20. The use according to claim 19,
wherein the sample tubes having the samples containing nucleic acid are provided in a predetermined and variable configuration.

21. The use according to claim 19,
wherein a portion containing at least one sample is stamped out of a sample carrier using a blade, this blade being situated on the top of a sample tube.

22. The use according to claim 19,
wherein a portion containing at least one sample is stamped out of a sample carrier using a blade, this blade being situated at the lower end of the top part and/or at the upper end of the bottom part of a sample tube.

23. The use according to claim 19,
wherein a portion containing at least one sample is stamped out of a sample carrier using a blade, this blade being situated on a manipulator of a system for storing and providing multiple samples containing nucleic acid.

24. The use according to claim 19,
wherein each sample tube is closed on its top by a film or a stopper.
